(19) United States
(12) Patent Application Publication
(10) Pub. No.: US 2021/0331448 A1
(43) Pub. Date: Oct. 28, 2021

(54) POLYMER METAL HYBRID LAMINATES

(71) Applicant: DUPONT POLYMERS, INC., Wilmingtoon, DE (US)

(72) Inventors: Robert A. Coy, SYDENHAM (CA); Paul J. Kane, BLOOMFIELD HILLS, MI (US); Everette R. Rinehart, PLEASANT RIDGE, MI (US); Tyler J. Auvil, LAKE ORION, MI (US)

(21) Appl. No.: 17/284,028

(22) PCT Filed: Oct. 9, 2019
(86) PCT No.: PCT/US19/55369

§ 371 Date: Apr. 9, 2021

Related U.S. Application Data
(60) Provisional application No. 62/743,066, filed on Oct. 9, 2018.

(51) Int. Cl. B32B 15/088; B32B 7/12; B32B 15/20; B32B 15/18; B29C 45/00; B29C 45/14

(52) U.S. Cl. CPC B32B 15/088; B32B 7/12; B32B 15/20; B29K 2077/00; B29C 45/0001; B29C 45/14; B32B 15/18

(57) ABSTRACT

Provided herein is a polymer metal hybrid (PMH) laminate comprising a metal layer A; at least one adhesive layer B in direct contact with metal layer A; and a surface layer C comprising at least one polyamide. In the PMH laminate, adhesive layer B comprises epoxy functionality and does not comprise an epoxy curing agent; and surface layer C is a monolayer, bilayer, or multilayer film. Further provided are methods of producing the PMH laminates, overmolded PMH laminates, methods of producing the overmolded PMH laminates, and articles obtained using the PMH laminates.

### CROSS-REFERENCE TO RELATED APPLICATION

This application claims priority under 35 U.S.C. § 365 to U.S. Provisional Application No. 62/743,066, filed on Oct. 9, 2018, which is incorporated herein by reference in its entirety.

### FIELD OF THE INVENTION

Described herein are novel polymer metal hybrid (PMH) laminates and improved processes for preparing these PMH laminates. Also described are overmolded PMH laminates, methods for preparing the overmolded PMH laminates, and articles obtained using the PMH laminates.

### BACKGROUND OF THE INVENTION

Several patents and publications are cited in this description in order to more fully describe the state of the art to which this invention pertains. The entire disclosure of each of these patents and publications is incorporated by reference herein.

There is a current and general desire in the automotive, aircraft, and other fields to reduce the weight of various components, in general to reduce fuel consumption. There are many known methods for adhering metals to polymers; however, known methods may be expensive, messy, emit high VOCs, require clamping and curing, or have limited time windows to attach the metal to the polymer once an adhesive is activated. Such processes provide end use articles having very high bond strength between the metal and the polymer, however.

For example, US Patent Application No. 2010/0310878 describes heat curing epoxy resins which can be used as body shell adhesives.

WO 2014108553 A1 describes bonding a polyamide surface with a metal surface by mixing an acrylic-based monomer, at least one epoxy resin, which has more than one epoxy group per molecule on average, at least one bifunctional molecule, which is reactive with the acrylic-based monomer and the epoxy resin, at least one impact modifier, at least one radical former, and at least one catalyst for the radical formation, applying the mixture to a first surface made of polyamide and/or a second surface to be connected to the first surface.

WO 2010094599 A1 describes bonding a metal to a polymer using an adhesive based on epoxides and an initiator component for the epoxy based adhesive.

WO 20150361316 A1 describes metal plastic hybrid components prepared using an adhesion promoter composition comprising an epoxy based resin or precondensate and a catalyst for bonding a metal to a plastic.

U.S. Pat. No. 5,024,891 describes polyamide resin metal laminates wherein an epoxy layer is applied to a metal substrate and subsequently heat treated before lamination of a polyamide onto the epoxy surface.

Nevertheless, there remains a need for even lighter-weight articles and for even more efficient methods of manufacturing the articles.

### SUMMARY OF THE INVENTION

Accordingly, provided herein is a polymer metal hybrid (PMH) laminate comprising a metal layer A; at least one adhesive layer B in direct contact with metal layer A; and a surface layer C comprising at least one polyamide. In the PMH laminate, adhesive layer B comprises epoxy functionality and does not comprise an epoxy curing agent; and surface layer C is a monolayer, bilayer, or multilayer film. Further provided are methods of producing the PMH laminates, overmolded PMH laminates, methods of producing the overmolded PMH laminates, and articles obtained using the PMH laminates.

### DETAILED DESCRIPTION OF THE INVENTION

Unless otherwise defined, all technical and scientific terms used herein have the same meaning as commonly understood by one of ordinary skill in the art to which this invention belongs. Although methods and materials similar or equivalent to those described herein can be used in the practice or testing of the present embodiments, suitable methods and materials are described below. The materials, methods, and Examples described herein are illustrative only and not intended to be limiting.

The following abbreviations and definitions are to be used to interpret the meaning of the terms discussed in the description and recited in the claims.

### Abbreviations

“h” or “hrs” refers to hours
“%” refers to the term percent
“wt %” refers to weight percent
“parts” refers to parts by weight
“g” refers to grams
“mol %” refers to mole percent
“mil” or “mils” refers to thousandths of an inch; 1 mil is 0.001 inches.
“cc” refers to cubic centimeter
“min” refers to minutes
“kg” refers to kilogram
“mp” refers to melting point

### Definitions

As used herein, the article “a” refers to one as well as more than one and does not necessarily limit its referent noun to the grammatical category of singular number.

As used herein, the term “article” refers to an item, thing, structure, object, element, device, etc. that is in a form, shape, configuration that is suitable for a particular use/purpose without further processing of the entire entity or a portion of it.

An article may comprise one or more element(s) or subassembly(ies) that either are partially finished and awaiting further processing or assembly with other elements/subassemblies that together will comprise a finished article. In addition, as used herein, the term “article” may refer to a system or configuration of articles.

As used herein, the term “solution” refers to mixtures of ingredients in which the ingredients may be dissolved, suspended, or dispersed in a solvent. In an aqueous solution, the other ingredients are dissolved, suspended, or dispersed in water.

As used herein, the term “pure aluminum” refers to aluminum metal which comprises at least 99 wt. % aluminum.

As used herein, the term “aluminum alloy” refers to aluminum metal which comprises less than 99 wt. % aluminum.

As used herein, the term “epoxy component” refers to at least one epoxy-containing molecule which has at least 1 epoxy functional group per molecule of the epoxy component. “Epoxy component” refers to both an epoxy component comprising a single element having epoxy functionality and to an epoxy combination comprising two or more different elements having epoxy functionality.

As used herein, the term “flexural modulus” refers to test values obtained on an overmolded polymer-metal hybrid test sample according to ISO 178. As used herein, when a sample is tested according to “ISO 178”, the standard method is ISO178:2010A, using a span of 50.8 mm, support radius of 5 mm, a nose radius of 5 mm and a cross-head speed of 50.8 mm/min. Samples were tested with the aluminum side, that is, the bare metal side, facing up. The polymer-metal hybrid test sample has an A/B/C structure in which surface layer C can be overmolded or further bonded to polymer layer D.

As used herein, the term “spring constant” refers to the bending stiffness of PMH or overmolded PMH articles and is calculated from a 3-point bending formula, as described in the Examples, below, using data obtained from testing the samples according to the ISO 178 test method.

As used herein, the term “initial flexural modulus” refers to test values obtained on an overmolded polymer-metal hybrid test sample according to ISO 178 and before any thermal cycling (zero thermal cycles), humidity exposure (0 hrs.), or any other environmental exposure. The polymer-metal hybrid test sample has an A/B/C or A/B/C/D structure.

As used herein, the terms “lap shear” and “lap shear strength” refer to test values obtained according to ASTM D3163-01(2014). The test sample size was 25.4 mm wide with a lap length of 3.175 mm, and the cross-head speed was 0.05 inch/min. This test determines the interfacial adhesion or joint strength between two layers of materials. When multiple layers are present, such as 3 layers, test values represent the weakest adhesion value or joint strength between the various layers.

As used herein, the terms “initial lap shear” and “initial adhesion” refer to the interfacial adhesion between at least two layers of materials as formed before exposure to any environmental conditioning tests such as long term humidity exposure and/or elevated temperature cycles.

As used herein in descriptions of multilayer structures, the symbol “I” represents a boundary between contiguous layers. No third layer is interposed between two contiguous layers.

As used herein, the term “A/B/C structure” refers to a laminated structure or multilayer film comprising an adhesive layer B, a metal layer A, and a surface layer C in the stated order. Specifically, in an “A/B/C” structure, layer B is between layers A and C. Preferably, layer A is in direct contact with layer B. Also preferably, layer B is in direct contact with layers A and C.

### Ranges and Preferred Variants

Any range set forth herein expressly includes its endpoints unless explicitly stated otherwise. Any range set forth herein, for example a range of an amount, concentration, or other value or parameter, includes all possible ranges formed from any possible upper range limit and any possible lower range limit that are within the range, inclusive of the endpoints, regardless of whether such pairs of upper and lower range limits are expressly set forth herein. Compounds, processes and articles described herein are not limited to specific values disclosed in defining a range in the description.

The disclosure herein of any variation in terms of materials, chemical entities, methods, steps, values, and/or ranges, etc., whether identified as preferred or not, of the processes, compounds and articles described herein specifically includes any possible combination of materials, methods, steps, values, ranges, etc. For the purpose of providing photographic and sufficient support for the claims, any disclosed combination is a preferred variant of the processes, compounds, and articles described herein.

In this description, if there are nomenclature errors or typographical errors regarding the chemical name any chemical species described herein, including curing agents of formula (I), the chemical structure takes precedence over the chemical name. And, if there are errors in the chemical structures of any chemical species described herein, the chemical structure of the chemical species that one of skill in the art understands the description to intend prevails.

Described herein are PMH laminates having a unique combination of layers and novel processes for preparing these PMH laminates. PMH laminates described herein comprise a metal layer A, an adhesive layer B, a surface layer C, and optionally, an overmolded polymer layer D, having an A/B/C or, optionally, an A/B/C/D structure.

Additionally, if desired, adhesive layer B may be present on both surfaces of metal layer A with surface layer C being present on adhesive layer B such that the resulting PMH laminate has an C/B/A/B/C structure. These C/B/A/B/C structures may be overmolded, further bonded, or bonded by other means to Layer D on one or both sides to provide an overmolded D/C/B/A/B/C or D/C/B/A/B/C/D structure.

These PMH laminates can be prepared by processes which use no solvents and which do not require clamping different layers together to obtain the finished part.

More specifically, the PMH laminates described herein comprise:

A) a metal layer;

B) at least one adhesive layer in direct contact with metal layer A;

C) a surface layer comprising at least one polyamide;

wherein:

adhesive layer B comprises epoxy functionality;

adhesive layer B does not comprise an epoxy curing agent; and

surface layer C is a monolayer, bilayer, or multilayer film.

### Metal Layer A

Metal layer A used in the PMH laminates described herein may comprise a variety of metals, including, without limitation, iron, stainless steel, brass, copper, aluminum, magnesium, titanium, and metal alloys. Lighter weight metals are preferred, such as aluminum, titanium, and magnesium, for example.

Metals used as metal layer A can be the pure metal (comprising at least 99 wt % of the metal) or a metal alloy. The metal alloy may comprise one or more other metals. Preferably, the content of the primary metal in the alloy is at least about 80 mass percent.

Depending on the metal used as metal layer A, the metal surface may or may not need to be cleaned before applying the adhesive layer B, depending on the source of the metal layer. For example, metal suppliers may use various lubricants and process aids to improve web handling. Some conversion coated metals may already provide a stable, clean surface free of oils and contaminants. Typically, however, the metal surface is cleaned with a surfactant/water solution or degreasing solution to remove waxes and other surface impurities before application of adhesive layer B. Other suitable treatments for the metal surface include acid etching, abrasion, flame or corona treatment before lamination to improve performance.

As used herein, the “metal layer A” may be planar, as, for example, a metal film or sheet. Alternatively, “metal layer A” may be shaped or formed. For example, “metal layer A” may be a rod, a cylinder, or a tube with a cross-section of any shape, or any three-dimensional object that is capable of being covered with adhesive layer B and overmolded with polyamide surface layer C. See, for example, Intl. Patent Appln. claiming priority to U.S. Provisional Appln. No. 62/743,094 (filed on Oct. 9, 2018), Atty. Docket No. AD8233 WOPCT, filed concurrently herewith.

### Adhesive Layer B

The composition of adhesive layer B may be selected from various materials including molecules, oligomers, or polymers comprising at least one epoxy functional group. Preferred molecules have a molecular weight of 500 Da or less. Examples of suitable materials for use in adhesive layer B include any molecules having at least one epoxy functional group per molecule. Such epoxy functional groups must be capable of reacting with the free amine and/or acid end groups of polyamide resins used as surface layer C. U.S. Pat. Nos. 6,974,846 and 7,008,983 describe epoxy-containing molecules that may be reacted with polyamides.

A preferred epoxy material comprises at least one diphenolic epoxy condensation polymer, which is known in the art, such as, for example, condensation polymers of epichlorohydrin with a diphenolic compound. Also preferred is a 2,2-bis(p-glycidyl) (oxyphenyl) propane condensation product with 2,2-bis(p-hydroxyphenyl)propane and similar isomers. Commercially available diphenolic epoxy condensation polymers include the EPON™ 800 resin series, available commercially from Momentive Specialty Chemicals of Columbus, Ohio

Preferred epoxy materials comprise at least one epoxy functional group, but may comprise two or more epoxy functional groups per molecule, oligomer, or polymer of the epoxy material. The epoxy material should comprise not more than about 16, preferably not more than 10, and even more preferably not more than 6 epoxy functional groups per molecule of epoxy material or component. These molecules can be polymerized to make oligomers and polymers which comprise at least one or more epoxy functional group per molecule of the oligomer or polymer.

The epoxy groups of the epoxy material preferably comprise glycidyl ethers, and even more preferably, glycidyl ethers of phenolic compounds. An example of an epoxy material is a tetraglycidyl ether of tetra (parahydroxyphenyl) ethane. An example of a commercially available epoxy material is Araldite™ ECN 1299, available from Advanced Materials, Basel Switzerland. Another example is EPON™ 832, available from Momentive Specialty Chemicals, Inc.

Other epoxy materials may include epoxidized natural oils or fatty esters such as epoxidized soybean oil, epoxidized linseed/soybean oil, copolymers of styrene and glycidyl methacrylate, diglycidyl ethers of bisphenol A/bisphenol F, diglycidyl adducts of amines and amides, diglycidyl adducts of carboxylic acids, bis(3,4-epoxycyclohexylmethyl) adipate, vinylcyclohexene di-epoxide, epoxy phenol novolac and epoxy cresol novolac resins, epoxidized alkenes such as epoxidized alpha olefins, and epoxidized unsaturated fatty acids.

Adhesive layer B does not comprise an epoxy curing agent, secondary curing agent, or catalyst used to increase the reactivity of the epoxy functional group. Examples of epoxy curing agents, secondary curing agents, and catalysts include, without limitation, aliphatic amines, cycloaliphatic amines, polyamides, amidoamines, aromatic amines and anhydrides. Additional examples of these materials are described in ThreeBond Technical News, December 1990, available at https://www.threebond.co.jp/en/technical/technicalnews/pdf/tech32.pdf, last accessed on Oct. 4, 2019.

The adhesive layer B may further contain one or more adhesion promoters. Suitable adhesion promoters include, without limitation, silanes or titanates. Preferred adhesion promoters are silanes, more preferably mercaptosilanes, aminosilanes and epoxysilanes. Specific examples of preferred adhesion promoters include, without limitation, 4-aminobutyltrimethoxysilane, 4-aminobutyltriethoxysilane, 4-amino-3,3-diemethylbutyltrimethoxysilane,N-(2-aminomethyl)-3-aminopropyltriethoxysilane, 3-aminopropyltrimethoxysilane, 3-aminopropyltriethoxysilane, 3-aminopropyltris (methoxyethoxyethoxy)silane, N-(2-aminoethyl)-3-aminopropyltrimethoxysilane, 5,6-epoxyhexyltriethoxysilane, (3-glycidoxypropyl)triethoxysilane, (3-glycidoxypropyl) trimethoxysilane, 3-glycidoxylpropyltris(methoxyethoxyethoxy)silane. When used, the adhesion promoter may be present at a level of 0.01 to 10 wt %, preferably 0.1 to 7.5 wt, and more preferably 0.5 to 5.0 wt %, based on the total weight of the composition of adhesive layer B. The adhesion promoter may be added to adhesive layer B by any suitable method, including, without limitation, direct blending with epoxy resins or melt-mixing with polymeric components of adhesive layer B.

Additionally, some functionalized thermoplastic polyolefins containing carboxyl functional groups (acid or anhydride groups) either in the backbone or grafted onto the backbone, may be added in adhesive layer B to further promote bonding. When present, the amount of functionalized thermoplastic polyolefin ranges of 0.1 to 30 weight percent, based on the total weight of the adhesive layer B. The presence of this functionalized polymer in adhesive layer B is independent of its presence in surface layer C.

Adhesive layer B may further optionally include one or more powdery, granular or tabular filler agents such as mica, talc, kaolin, silica, calcium carbonate, glass beads, glass flakes, glass microballoons, clay, wollastonite, montmorillonite, titanium oxide, zinc oxide, and graphite may be added to promote desirable failure mode or further lighten the structure. When present, the total amount of the filler agent(s) is preferably from 0.1 to 50 wt %; from 0.1 to 20 wt %, from 5 to 50 wt %; from 5 to 20 wt %; from 5 to 10 wt %; or about 5 wt %, based on the total weight of the adhesive layer B.

Adhesive layer B may be applied to one surface or both surfaces of metal layer A, when metal layer A is planar, or to one or more surfaces, when metal layer A has a three-dimensional shape, at a concentration ranging from about 0.5 to about 5 ml/sq. ft. of metal surface. Preferably, the concentration ranges from about 0.5 to about 3 ml/sq. ft., more preferably about 0.75 to about 2 ml/sq. ft. This concentration is based on undiluted adhesive layer B which does not comprise any solvents. In other words, in one preferred method of applying adhesive layer B, the materials comprising an epoxy component used herein to make adhesive layer B are preferably “neat”, that is, they do not comprise any solvent. Although such ranges are not expressly stated herein, all possible concentration ranges of adhesive layer B having endpoints between about 0.5 and about 5 ml/sq. ft., inclusive, are contemplated in these compositions.

Alternatively, in another preferred method of applying adhesive layer B, the materials comprising at least one epoxy functional group used to prepare adhesive layer B may be dissolved in a solvent and applied to metal layer A as a solution, suspension or dispersion. If a solvent is used, the concentration of the material(s) comprising epoxy functional groups remaining on the surface of metal layer A should be about 0.5 to about 5 ml/sq. ft. of metal surface after removal or evaporation of the solvent.

Typically, metal layer A may be heated to about 100° C. and adhesive layer B may be applied to metal layer A by methods commonly used in the art such as rolling or spraying. These methods may be used to prepare A/B laminates to which surface layer C is laminated or adhered to provide A/B/C structures. These A/B laminates do not need to be conditioned by heat treating before lamination of surface layer C onto the A/B laminate.

Surface layer C may be applied to A/B laminates at a temperature and during a time period that is sufficient to form A/B/C or C/B/A/B/C laminates which, when overmolded, bonded by alternative means, or further bonded to polymer D, provide overmolded PMH articles which have a desired combination of properties including lap shear, humidity resistance, and thermal stability.

### Surface Layer C

The composition of surface layer C may be selected from the group consisting of aliphatic polyamides, semiaromatic polyamides, and blends of two or more thereof. The polyamides may be homopolyamides, such as PA6, and/or copolyamides. The polyamides can be amorphous or semi-crystalline.

Fully aliphatic polyamide resins may be formed from aliphatic and alicyclic monomers such as diamines, dicarboxylic acids, lactams, aminocarboxylic acids, and their reactive equivalents. A suitable aminocarboxylic acid includes 11-amino-dodecanedioic acid. As described herein, the term “fully aliphatic polyamide resin” refers to copolymers derived from two or more such monomers and blends of two or more fully aliphatic polyamide resins. Linear, branched, and cyclic monomers may be used. Carboxylic acid monomers useful in the preparation of fully aliphatic polyamide resins include, but are not limited to, aliphatic carboxylic acids, such as for example adipic acid (C6), pimelic acid (C7), suberic acid (C8), azelaic acid (C9), sebacic acid (C10), dodecanedioic acid (C12) and tetradecanedioic acid (C14). Useful diamines include those having four or more carbon atoms, including, but not limited to tetramethylene diamine, pentamethylene diamine, hexamethylene diamine, octamethylene diamine, decamethylene diamine, 2-methylpentamethylene diamine, 2-ethyltetramethylene diamine, 2-methyloctamethylene diamine; trimethylhexamethylene diamine and/or mixtures thereof. Suitable examples of fully aliphatic polyamide resins include PA6; PA66, PA46, PA610, PA612, PA614, P 613, PA 615, PA616, PA11, PA12, PA10, PA 912, PA913, PA914, PA915, PA616, PA936, PA1010, PA1012, PA1013, PA1014, PA1210, PA1212, PA1213, PA1214 and copolymers and blends of the same.

Preferred aliphatic polyamides include poly(hexamethylene adipamide) (PA66), polycaprolactone (PA6), and poly(tetramethylene hexanediamide) (PA46), and PA6/66. Blends of any of the foregoing aliphatic polyamides are also suitable, especially blends of PA6 with PA66 and PA610 or PA612. The weight ratio of polyamides in blends of PA6/PA66/PA610 or PA6/PA66/PA612 may range from about 30 to 50/20 to 50/10 to 40 weight percent respectively in which the total of the weight percentages of the three polyamides is 100 weight percent.

Semiaromatic polyamides may also be used and include poly(hexamethylene terephthalamide/2-methylpentamethylene terephthalamide) (PA6T/DT); poly(decamethylene terephthalamide) (PA10T), poly(nonamethylene terephthalamide) (PAST), hexamethylene adipamide/hexamethylene terephthalamide/hexamethylene isophthalamide copolyamide (PA66/6T/6I); poly(caprolactam-hexamethylene terephthalamide) (PA6/6T); and poly(hexamethylene terephthalamide/hexamethylene isophthalamide) (PA6T/6I) copolymer.

Blends of aliphatic polyamides, semiaromatic polyamides, other thermoplastic resins and polymers, and combinations of two or more of these may also be used. Other thermoplastic resins that are suitable for use in surface layer C include, without limitation, polyethylenes, polypropylenes, ethylene alpha-olefin copolymers, ethylene propylene diene rubbers (EPDM), polystyrene, ionomers and combinations of two or more of these materials.

Rheology modifiers, heat stabilizers, colorants, antioxidants, lubricants, and other additives may be added as adjuncts to the polyamide resins. These additives may be added to the composition of surface layer C by methods that are generally known in the art. Suitable amounts of these additives are also known in the art. Preferably, however, no individual additive is present in an amount of greater than 1 or 5 wt %, and the sum of the weight percentages of the additives in surface layer C is not greater than 2, 5, or 10 wt %, based on the total weight of the composition of surface layer C.

Additionally, some functionalized thermoplastic polyolefins containing carboxyl functional groups (acid or anhydride groups) either in the backbone or grafted onto the backbone, may be included in surface layer C to further promote bonding. The presence of this functionalized polymer in surface layer C is independent of its presence in adhesive layer B.

Additionally, surface layer C may be a laminate comprising one film layer of an aliphatic or semi-aromatic polyamide or blends of aliphatic and/or semi-aromatic polyamides with a second film layer of a different polyamide or blend of polyamides. For example, one film layer may be an aliphatic polyamide or blend of aliphatic polyamides and a second film layer may be a semiaromatic polyamide such as PA610, PA610/6T, PA612, or PA612/6T. In other words, surface layer C may comprise a bilayer film or a multilayer film. Such laminates may be prepared by a belt laminator or by co-extrusion, for example. When such laminates are used, it is preferred that the outer surface of surface layer C, the layer that may be in direct contact with overmolded polymer D, surface layer C include at least one long chain diacid or diamine monomer. It is believed that the long-chain comonomers provide low moisture absorption and high barrier, along with low crystallinity and an appropriate melt temperature, and that these polyamides bond well to the overmolded polyamide resin.

Further in this connection, when surface layer C comprises more than one layer, the functionalized thermoplastic polyolefin may be included in one or more of the layers. Preferably, the functionalized thermoplastic polyolefin is included in the innermost layer, that is, the layer that is in direct contact with adhesive layer B. The functionalized thermoplastic may be added to surface layer C in an amount of 0.1 to 30 weight percent, preferably 0.1 to 10 weight percent, based on the total weight of surface layer C, or, when surface layer C is a laminate, based on the total weight of the film layer in which the functionalized thermoplastic polyolefin is used.

### Process to Prepare PMH Laminates

PMH laminates having an A/B/C or C/B/A/B/C structure may be prepared by first applying or coating adhesive layer B onto one or both surfaces of metal layer A by typical methods to obtain an A/B or B/A/B laminate. These methods include spraying, rolling, dipping, and other methods known in the art. Essentially any process may be used to apply adhesive layer B onto metal surface A, and most are easily within the skill of one of skill in the art.

Metal layer A may be pre-heated before application of adhesive layer B, if necessary or desirable to reduce epoxy viscosity when no solvents are used, for example to facilitate easier application or uniform coating. It has been found, however, that conditioning the A/B laminate by heating before lamination of surface layer C onto the A/B laminate is not necessary or required to achieve the desired combination of physical properties. When the A/B laminates are thermally conditioned, however, preferably they are not heated to temperatures above about 350° C., above about 325° C., more preferably not above about 300° C., about 250° C., or about 200° C., still more preferably not above 150° C. or above 110° C., before adhesion or lamination to surface layer C. If over-heated, the epoxy will react with itself and reduce functionality available for the metal and polyamide film bond.

It is preferred that surface layer C should be in film form when applied to an A/B laminate. The method used to prepare the film layer is not critical and any known method may be used to prepare the film. Surface layer C should be at least 50 microns in thickness. When applied in film form, surface layer C is laminated to an A/B laminate to form a PMH laminate having an A/B/C structure using common methods known in the art. These include belt laminators, oven conveyors with nip roll assemblies, and heated presses. Alternately, when metal layer A has a non-planar or irregular shape, extrusion coating or wrapping pre-cast film onto metal layer A may be used to produce an A/B/C structure.

Once surface layer C has been initially laminated or adhered to the A/B laminate to form an initial PMH laminate having an A/B/C structure, the initially formed PMH laminate is subsequently thermally conditioned for a time period and temperature sufficient to provide the desired PMH laminate. For example, after initial lamination, thermal conditioning of the A/B/C structure to provide a PMH laminate may occur at a temperature of 235° C. for 8 minutes to achieve the desired physical properties. In general, the conditioning time and temperature are determined by the melt point and available amine and carboxyl ends of the polyamide layer combined with the available epoxide functionality of the selected epoxy resin.

The temperature of the initial lamination of surface layer C to the A/B laminate should be above the melting point of the polyamide used in surface layer C but preferably below 400° C., more preferably below about 350° C., and most preferably below about 325° C., but not below 210° C.

The temperature at which surface layer C is initially laminated to or comes into contact with the A/B laminate may be above or below the thermal conditioning temperature of the A/B/C laminate. After surface layer C is initially laminated to the A/B laminate to form an A/B/C laminate using, for example, a belt laminator with nip rolls, the A/B/C laminate is thermally conditioned by passage through a heating chamber at the desired temperature, preferably below 350° C., and for the desired time period, followed by passage through a cooling section, to provide the desired PMH laminate. These PMH laminates may be overmolded with polymer D.

In a preferred process, flat coil or sheets of metal layer A are laminated with adhesive layer B and surface layer C. A non-planar PMH article may be shaped from a planar A/B/C or C/B/A/B/C layer structure before layer D is overmolded, further bonded or adhered by other means to the shaped PMH article. Extrusion coating or wrapping non-planar surfaces of metal layer A are alternative suitable methods.

### Overmolding Polymer D

Overmolding polymer D may be overmolded, further bonded, or adhered by other means onto PMH laminates described herein to provide overmolded PMH articles. Overmolding polymer D comprises a polyamide which may be selected from the same or different polyamides as those which may be used for surface layer C.

It is preferred, though not required, that the same species of polymer be used for both surface layer C and overmolding polymer D. In other words, if a semi-aromatic polyamide is used in surface layer C, then the overmolding polymer preferably comprises at least 5%, preferably at least 25%, more preferably at least 50%, and most preferably at least 70% semi-aromatic polyamide, by weight based on the total weight of the composition of overmolding polymer D. It is also desirable that surface layer C have essentially the same or lower melting point and the same or lower heat of fusion than the polyamide of overmolding polymer D.

Overmolding polymer D may also comprise one or more functionalized thermoplastic polyolefins containing carboxyl functional groups (acid or anhydride groups) either in the backbone or grafted onto the backbone of the thermoplastic polyolefin. The functionalized polymer may be added to the composition of the overmolding polymer D by means that are known in the art. Preferably, the composition of the overmolding polymer D comprises less than 50 weight percent, more preferably less than 30 weight percent, and still more preferably less than 12.5 total weight percent of the functionalized thermoplastic polyolefin(s) by weight based on the total weight of the composition of overmolding polymer D. The functionalized thermoplastic polyolefin(s) included in the composition of overmolding polymer D may be the same as or different from the functionalized thermoplastic polyolefin(s) included in adhesive layer B or surface layer C, if any. When the functionalized thermoplastic polyolefin(s) are included in surface layer C, the same the functionalized thermoplastic polyolefin(s) or different one(s) are preferably included in the composition of overmolding polymer D, in the same amount(s) or in different amount(s).

The composition of overmolding polymer D may additionally comprise reinforcing agents for improving mechanical strength and other properties, which may be a fibrous, tabular, powdery or granular material and may include glass fibers, carbon fibers including PAN-derived or pitch-derived carbon fibers, gypsum fibers, ceramic fibers, asbestos fibers, zirconia fibers, alumina fibers, silica fibers, titanium oxide fibers, silicon carbide fibers, rock wool, powdery, granular or tabular reinforcing agents such as mica, talc, kaolin, silica, calcium carbonate, glass beads, glass flakes, glass microballoons, clay, wollastonite, montmorillonite, titanium oxide, zinc oxide, and graphite. Two or more reinforcing agents may be combined in these compositions; moreover, these compositions may include any or every combination of the reinforcing agents described herein.

The reinforcing agent may be sized or unsized. The reinforcing agent may be processed on its surface with any known coupling agent (e.g., silane coupling agent, titanate coupling agent) or with any other surface-treating agent.

If fibers are used as the reinforcing agent, the fibers may have a circular or non-circular cross section. A fiber having a non-circular cross section refers to a fiber having a major axis lying perpendicular to a longitudinal direction of the fiber and corresponding to the longest linear distance in the cross section. The non-circular cross section has a minor axis corresponding to the longest linear distance in the cross section in a direction perpendicular to the major axis. The non-circular cross section of the fiber may have a variety of shapes including a cocoon-type (figure-eight) shape; a rectangular shape; an elliptical shape; a semielliptical shape; a roughly triangular shape; a polygonal shape; and an oblong shape. As will be understood by those skilled in the art, the cross section may have other shapes. The ratio of the length of the major axis to that of the minor access is preferably between about 1.5:1 and about 6:1. The ratio is more preferably between about 2:1 and 5:1 and yet more preferably between about 3:1 to about 4:1. The fiber may be long fibers, chopped strands, milled short fibers, or other suitable forms known to those skilled in the art.

Glass fibers, carbon fibers, glass flakes, glass beads, mica, and combinations of these are preferred. Suitable glass fibers include, without limitation, chopped strands of long or short glass fibers and milled fibers of long or short glass fibers.

If used in overmolding polymer D, the amount of the reinforcing agent ranges from about 10 to about 70 weight percent, preferably about 15 to about 60 weight percent, and more preferably about 15 to about 55 weight percent based on the sum of the total weight of all ingredients used in overmolding polymer D. All possible ranges of the weight of reinforcing agent between 10 and 70 weight percent, inclusive, based on the total weight of the composition of overmolding polymer D, are suitable for use in the overmolded PMH articles described herein.

The composition of overmolding polymer D may also comprise one or more rheology modifiers, heat stabilizers, colorants, antioxidants, lubricants, and other additives as adjuncts so long as the additives do not adversely affect the properties of the overmolding polymer D or the resulting overmolded PMH articles. It is preferred that the total concentration of all of the additives not exceed 5 wt percent, based on the total weight of all ingredients in the composition of overmolding polymer D.

### Process for Making PMH Articles

PMH articles of a desired form or shape may be overmolded with overmolding polymer D to provide overmolded PMH articles having an A/B/C/D or D/C/B/A/B/C/D structure. One suitable process to prepare the overmolded PMH articles described herein comprises the steps of:
a) placing a PMH laminate having the A/B/C structure into a heated mold on a molding machine with surface layer C facing outward, i.e., towards the mold cavity and away from the nearest surface of the mold;
b) closing the heated mold and further heating the PMH laminate to at least the T_{g} of the polyamide of surface layer C;
c) injecting into the heated mold overmolding polymer D onto surface layer C of the PMH laminate to provide an overmolded PMH article in which up to 100 percent of the exterior surface of the PMH laminate is overmolded;
d) allowing the overmolded PMH article to cool and solidify;
e) opening the mold and removing the overmolded PMH article.
   If a blend of polyamides is used in surface layer C, then the mold should be heated to a temperature at least equal to the lowest T_{g} of the polyamides used in the blend and is preferably heated to a temperature at least equal to the highest T_{g} of the polyamides used in the blend.

The entire surface of the PMH article or a portion of the surface of the PMH article may be overmolded. For designs in which only a portion of the surface will be overmolded, the mold may be tailored such that a portion of its interior surface is in direct contact with the complementary portion of surface layer C, that is, the portion of the PMH article that is not to be overmolded. This direct contact is such that molten overmolding polymer D is prevented or substantially prevented from interposition between surface layer C and the mold's interior surface. In this configuration, at least a portion of surface layer C is in direct contact with the interior surface of the mold. As described above, the mold may be heated to a temperature at least equal to the Tg of the polymers in the surface layer C. In the absence of surface layer C, laminated epoxy layer B may cure in lamination and therefore it will not bond to overmolding polymer D. Alternatively, the wet epoxy coating of layer B may be removed from metal layer A by high pressure flow of polymer D in the overmolding process. In either case, in the absence of surface layer C, the interior of the mold is likely to be contaminated by residual cured epoxy material originating from adhesive layer B.

Accordingly, an advantage of overmolded PMH articles as described herein is that during manufacture of overmolded PMH articles, at least 50 overmolded PMH articles can be consecutively produced on the same molding machine without the surface of the mold cavity becoming contaminated with measurable amounts of contaminants from the PMH laminate. Specifically, after 50 repetitions of steps (a) to (e) the total mold deposits are 0.25 grams or less per square inch of mold surface which is in contact with surface layer C when the mold is closed. An alternative way of describing this advantage of these PMH articles is that after 50 repetitions of steps (a) to (e), total mold deposits are 50 percent less, preferably 90 percent less, than the total mold deposits of an identical process using a PMH laminate lacking surface layer C.

Examples of PMH articles include automotive components such as front end modules, lift-gates, and cross car beams.

### Overmolded PMH Articles

The overmolded PMH articles described herein have improved retention of physical properties such as flexural modulus and lap shear after exposure to various environmental conditions compared to otherwise identical PMH articles that do not comprise surface layer C. One advantage of the overmolded PMH articles described herein is that the overmolding process allows for the introduction of lightweight structural elements, such as for example such as glass reinforced polyamide and carbon fiber reinforced polyamide, to the PMH articles. However, if adhesive layer B has insufficient adhesion properties to either surface layer C or metal A, then the resulting overmolded PMH article may exhibit undesirable or inferior properties such as flexural modulus or lap shear both initially and after environmental exposure.

Overmolded PMH articles as described herein exhibit a desired combination of physical properties including an initial lap shear (23° C.) of at least 11.5 MPa, an initial lap shear (85° C.) of at least 5.5 MPa, a lap shear after humidity testing (humidity resistance) of at least 9 MPa when measured according to ASTM D316, and a lap shear after thermal cycling (thermal stability) of at least 11.5 MPa.

The following examples are provided to describe the invention in further detail. These examples, which set forth a preferred mode presently contemplated for carrying out the invention, are intended to illustrate and not to limit the invention.

### Examples

### Materials

In the compounds, processes, and articles exemplified in the tables below, the following materials were used. All percent values are by weight unless explicitly indicated otherwise under specific circumstances.

AL1: a maleic anhydride grafted polyethylene thermoplastic adhesive commercially available from The Dow Chemical Company of Midland Mich. as Bynel 41E755 Adhesive Resin
AL2: a maleic anhydride grafted polypropylene thermoplastic adhesive available commercially from The Dow Chemical Company of Midland Mich. as Bynel 50E739 Adhesive Resin. Melt point of 142 C, MFR of 6.0 g/10 min (230 C/2.16 kg), Density of 0.89, as reported by manufacturer.
AL3: an epoxy difunctional bisphenol A resin available from Hexion, Inc., of Columbus, Ohio, containing 185-192 g/eq weight, based on equivalents of epoxide moieties, as measured by ASTM D1652 (as stated in manufacturer's technical data sheet).
SL1: a poly(hexamethylene terephthalamide/hexamethylene decanediamide) (modified PA610) having a melt point of 214° C.
SL2: a PA6 having a melt point of 220° C., a density of 1.12 g/cc and a relative viscosity of 3.89-4.17 (as per ISO 307)
SL3: a PA6,6 having a melt point of 189° C., a density of 1.12 g/cm³ and a relative viscosity of 3.89-4.17 (as per ISO 307)
SL4: a polyamide terpolymer PA6/66/610 (40/36/24 wt %) with a melt point of 156° C., a specific gravity of 1.08 and a RV of 70-100 (ISO 307)
PA1: a PA66 poly(hexamethylene adipamide) having a melt point of 262° C., a viscosity of 100 cm³ and comprising 50 wt % glass fibers available from DuPont de Nemours, Inc., of Wilmington, Del. (DuPont) as Zytel® polyamide 70G50HSLA BK039B
PA2: Modified PA610 having a melt point of 214° C.
PA3: PA 612 having a melting point of 220° C. and a density of 1.06 g/cc available from DuPont as Zytel® polyamide FE310001
PA4: Modified PA612 available from DuPont as Zytel® polyamide FE310088
PA5: PA610 having a melting point of 225° C. and a density of 1.08 g/cc available from DuPont as Zytel® polyamide RS LC3090
PA6: PA1010 having a melting point of 203° C. and a melt viscosity of 111 cm³/g, available from DuPont as Zytel® polyamide RS LC1010
PA7: PA6 having a melt point of 220° C., a density of 1.12 g/cc and a relative viscosity of 3.89-4.17 per ISO 307
PA8: PA66 having a melt point of 189° C., a density of 1.12 g/cm³ and a relative viscosity of 3.89-4.17 per ISO 307
PA9: poly(hexamethylene hexadecanediamide) (PA616) having a melt point of 200° C.
PA10: a poly(hexamethylene dodecanediamide) (PA612) having a melt point of 280° C. with an IV of 1.37.

### PA11: Same as SL4

EVOH: an ethylene-vinyl alcohol co-polymer having 32 mol % copolymerized residues of vinyl alcohol with a melt point of 183° C. and a density of 1.19 g/cc, available from Kuraray America Co. as Eval F171B.

### Sample Preparation:

To determine the adhesive properties of overmolded PMH articles, test samples were prepared as follows: aluminum coupons (5052-H32 available from Online Metals via onlinemetals.com) having a thickness of 0.063 inches (1.6 mm) and 100 mm width and length (metal layer A) were heated to 100 C and adhesive layer B was rolled onto metal layer A to a thickness of approx. 11 microns (0.000433 inches) to make A/B laminates. The A/B laminates were thermally laminated to surface layer C having a thickness 5 mil (125 um) (0.005 inch) using a Glenro MPH laminator to provide PMH test samples having an A/B/C structure. The PMH test samples were thermally conditioned at 235 C for 8 minutes and then cooled at 140 C for 2 minutes to provide PMH test samples used for overmolding.

The PMH test samples were cut into 101.6 mm×50.8 mm (4″×2″) (W by L) plates using a band saw. These plates were overmolded in a Nissie 180 Ton injection molding machine with PA1 into a 101.6 mm (4-inch)-wide by 127 mm (5-inch)-long by 3.175 mm (0.125 inch) thickness plaque. Thus, 3 inches of the overmolded plaque did not have metal underneath the overmolded polymer. Each plaque was then cut using a bandsaw into three test samples, each sample being 25.4 mm (1 inch) wide by 127 mm 5 inches) long, and a 12.7 mm (0.5 inch) waste strip was discarded from the plaques' outside edges. Specifically, along the 127 mm length of the molded plaque, both outer edges are waste. The resulting test samples have a 50.8 mm (2-inch)-long metal overmolded test sample on one end with a 76.2 mm (3 inch) polymer tab on the opposite end (no metal underneath). The polyamide layer on the metal overmolded area of the test sample was cut by hand (in a jig) to provide a 1 inch wide 0.125″ inch-long lap test area near the middle of the sample. A 25.4 mm wide×3.175 mm long lap test area located at 47.625 mm along the overmolded metal near the middle of the length of the test sample The cut tensile bar test samples were tested using an Instron 5966 and a 2000 lb. load cell at 0.05 inches/min according to ASTM D3163.

### Lap Shear

All lap shear measurements were made according to ASTM D3163-01 (2014), subsequently identified as ASTM D3163. All lap shear values are reported in units of MPa. Initial adhesion (initial lap shear) values and high temperature adhesion (initial lap shear at 85° C.) values were obtained on the overmolded polymer metal hybrid tensile bar test samples after molding and before the test samples were exposed to any subsequent environmental testing such as humidity exposure or elevated temperature cycling.

Lap Shear after Thermal Cycling (Thermal Stability)

Tensile bar test samples used for thermal stability testing were thermally cycled according to the following procedure:

Test samples were initially heated from room temperature (about 23° C.) to 85° C. at 2° C./minute and held at 85° C. for 200 minutes. The samples were then cooled from 85° C. to −35° C. over a period of 60 minutes (2° C./minute) and held at −35° C. for 60 minutes. The samples were then heated from −35° C. to 23° C. at 2° C./minute. This heating and cooling cycle was repeated for a total of 40 cycles to condition the test sample. Lap shear of the thermally cycled tensile bar test samples was determined according to ASTM D3163.

Lap Shear after Humidity Testing (Humidity Resistance)

Tensile bar test samples used for humidity resistance testing were exposed to 70% relative humidity (RH) and 60° C. for 1000 hrs. in a ThermoForma environmental chamber. After RH exposure, the test samples were removed from the environmental chamber and allowed to cool to room temperature (about 23° C.). The cooled test samples were tested for lap shear according to ASTM D3163.

### Flexural Modulus

Flexural modulus values for all samples were determined using a 3-Point flexural test according to ISO 178. An Instron 4469 tensile tester having a support radius of 5 mm, a nose radius of 5 mm and a support span of 50.8 mm was used to determine flexural modulus. All samples were tested with the metal layer of the aluminum coupon facing upward. Test samples were prepared according to the following procedure. Mechanically interlocked samples were prepared as follows:

Aluminum coupons (5052-H32 available from Online Metals) having a thickness of 0.063 inches (1.6 mm) and 100 mm width and length (metal layer A) were heated to 100 C and adhesive layer B was rolled onto metal layer A to a thickness of approx. 11 microns (0.00003937 inches) to make A/B laminates. The A/B laminates were thermally laminated to surface layer C having a thickness 5 mil (125 um) (0.005 inch) using a Glenro MPH laminator to provide PMH test samples having an A/B/C structure. The PMH test samples were thermally conditioned at 235 C for 8 minutes and then cooled at 140 C for 2 minutes to provide PMH test samples used for overmolding. The PMH test samples were cut into 12.7 mm wide by 127 mm long test samples using a band saw. Four holes, each 4.76 mm in diameter, were drilled through the test samples along the lengthwise centerline of the sample at equal intervals of 25.4 mm, on center. A 45 degree bevel was machined on the non-coated side of the drilled holes to increase their diameter at the metal surface to 6.0 mm to form mechanical fastening points.

Test samples which were not mechanically interlocked were prepared by the same method used to prepare the mechanically interlocked samples except no holes were drilled into the samples.

Both mechanically interlocked test samples and test samples which were not mechanically interlocked, as prepared above, were overmolded according to the following procedure:

Test samples were overmolded using a Nissie 180 Ton injection molding machine with PA1 into 12.7 mm (0.5 inch) wide by 127 mm (5 inch) long by 6.35 mm (0.25 inch) thick flex bars with the overmolding polymer D injected onto the side of the test sample comprising surface layer C (if present).

### Initial Flexural Modulus

Initial flexural modulus of the test samples (before thermal cycling (zero thermal cycles) or humidity exposure) was determined according to ISO 178.

### Spring Constant Bending Stiffness

Because the PMH test samples are multi-material flexural bars, the stiffness may be characterized by the spring constant “K” (Force versus deflection) which can be calculated from test sample (test bar) and flexural modulus data generated by ISO 178:2010 test method using the three-point bending formula K=(48×FM×I)/L³, where FM is the flexural modulus of the test sample, I is the second moment of inertia (which is derived from (1/12×width×height³ of the test sample)). Testing was performed with the metal side facing upward.

The results in table 1 show shear values achieved using various combinations of adhesive layers B and surface layers C when overmolded with reinforced polyamide. Table 1 clearly shows that when an epoxy containing adhesive layer B (AL3) is used in combination with a polyamide surface layer (Examples E1 and E2), the physical properties are superior to Comparative Examples C2, C3, C5, C6 and C7, which use a maleic anhydride grafted polymer as adhesive layer B (AL2). Comparative Examples C1 and C4 do not use a surface layer and fail to exhibit the desired combination of physical properties.

TABLE 1

| | C1 | C2 | C3 | C4 | C5 | C6 | C7 | E1 | E2 |
|---|---|---|---|---|---|---|---|---|---|
| Overmolded | PA1 | PA1 | PA1 | PA1 | PA1 | PA1 | PA1 | PA1 | PA1 |
| polymer D | | | | | | | | | |
| Adhesive | AL1 | AL1 | AL1 | AL2 | AL2 | AL2 | AL2 | AL3 | AL3 |
| layer B | | | | | | | | | |
| Surface | None | SL1 | SL2 | None | SL1 | SL2 | SL3 | SL4 | SL1/SL4¹ |
| layer C | | | | | | | | | |
| Initial lap | 7.5 | 10.0 | 10.7 | 10.5 | 14.4 | 12.6 | 14.3 | 26.8 | 27.9 |
| Shear (23° C.) | | | | | | | | | |
| Initial lap | 3.5 | 5.2 | 5.1 | 5.1 | 6.9 | 6.2 | 6.7 | 9.7 | 11.7 |
| Shear (85° C.) | | | | | | | | | |
| Lap Shear | 7.2 | 11.2 | 11.3 | 8.5 | 15.5 | 12.6 | 13.9 | 9.7 | 11.6 |
| (1000 hrs.) | | | | | | | | | |
| Humidity | | | | | | | | | |
| Lap Shear | 7.7 | 11.5 | 11.1 | 7.4 | 15.8 | 12.6 | 14.3 | 28.7 | 28.7 |
| (Thermally | | | | | | | | | |
| Cycled) | | | | | | | | | |

¹Bilayer film where SL1 is outside surface layer C and SL4 is in direct contact with AL3.

Table 2 shows the improvement in initial spring stiffness when an adhesive and surface layer are used in combination with mechanical interlocks. Example E3 shows considerable improvement in initial flexural modulus and initial spring stiffness compared to Comparative Example C8 which uses only mechanical interlocks. Comparative Examples C9 and C10 use maleic anhydride based adhesive layers (no epoxy) and exhibit inferior performance compared to Example E3.

TABLE 2

| | C8 | C9 | C10 | E3 |
|---|---|---|---|---|
| Overmolded Polymer | PA1 | PA1 | PA1 | PA1 |
| Adhesive Layer B | None | AL1 | AL2 | AL3 |
| Surface Layer C | None | SL1 | SL1 | SL1 |
| Mechanical Interlocked | Yes | Yes | Yes | Yes |
| Initial Flexural Modulus - MPa | 9934 | 14936 | 13876 | 17125 |
| (23° C.) | | | | |
| Initial Spring Stiffness - MPa | 986 | 1482 | 1377 | 1699 |
| (23° C.) | | | | |

Table 3 shows the use of different polyamides in surface layers C in combination with an epoxy adhesive layer (AL3). All examples in Table 3 use a bilayer film as surface layer C with SL1 as the outside layer and EVOH or the polyamide or polyamide blend listed in Table 3 as the inner layer in contact with the adhesive layer B (AL3). This was done to maintain a uniform bond between the outer layer of film C with the overmold layer D. Each structure was overmolded with PA1. The results in Table 3 show that desirable lap shear values are obtained when a variety of polyamides are used and when EVOH is used as surface layer C.

TABLE 3

| | Initial Lap | Initial Lap |
|---|---|---|
| Surface Layer C | Shear¹ (23° C.) | Shear¹ (85° C.) |
| PA6/PA66/PA610 (40/35/25)² | 26.8 | 9.5 |
| PA6/PA66 (50/50)² | 30.6 | 12.4 |
| PA6/PA610 (50/50)² | 29.1 | 13.4 |
| PA66/PA610 (50/50)² | 26.8 | 12.7 |
| PA2 | 31.9 | 10.9 |
| PA3 | 27.3 | 14.4 |
| PA4 | 27.9 | 14.0 |
| PA5 | 22.7 | 10.6 |
| PA6 | 30.3 | 11.6 |
| PA7 | 25.5 | 9.6 |
| PA8 | 28.6 | 10.8 |
| PA9 | 28.7 | 13.8 |
| PA10 | 26.9 | 13.9 |
| EVOH | 29.5 | 9.3 |
| PA11 | 25.0 | 11.0 |

¹values in MPa
²Physical blends (amounts by weight)

While certain of the preferred embodiments of this invention have been described and specifically exemplified above, it is not intended that the invention be limited to such embodiments. Various modifications may be made without departing from the scope and spirit of the invention, as set forth in the following claims.

1. A polymer metal hybrid laminate comprising:
A) a metal layer;
B) at least one adhesive layer in direct contact with metal layer A;
C) a surface layer comprising at least one polyamide;
wherein:
adhesive layer B comprises epoxy functionality;
adhesive layer B does not comprise an epoxy curing agent; and
surface layer C is a monolayer, bilayer, or multilayer film.

2. The polymer metal hybrid laminate of claim 1, wherein said metal layer is selected from the group consisting of aluminum, steel, and alloys of aluminum or steel.

3. The polymer metal hybrid laminate of claim 1, wherein said adhesive layer B comprises diphenolic epoxy condensation polymers.

4. The polymer metal hybrid laminate of claim 1, wherein said adhesive layer B further comprises an adhesion promoter.

5. The polymer metal hybrid laminate of claim 1, wherein said surface layer C comprises a polyamide selected from the group consisting of PA610, PA612, PA616, PA618, PA610/6T, PA612/6T, PA1010, and blends of two or more thereof.

6. A polymer metal hybrid article comprising:
A) a metal layer;
B) at least one adhesive layer in direct contact with metal layer A;
C) a surface layer comprising at least one polyamide; and
D) an overmolded polymer comprising at least one polyamide;
wherein:
adhesive layer B comprises epoxy functionality;
adhesive layer B does not comprise an epoxy curing agent;
surface layer C is a monolayer, bilayer, or multilayer film; and
overmolded polymer D is overmolded onto surface layer C.

7. The polymer metal hybrid article of claim 6, wherein said metal layer is selected from the group consisting of aluminum, steel, and alloys thereof.

8. The polymer metal hybrid article of claim 6, wherein said adhesive layer B comprises diphenolic epoxy condensation polymers.

9. The polymer metal hybrid article of claim 6, wherein said adhesive layer B comprises one or more adhesion promoters selected from the group consisting of silanes and titanates.

10. The polymer metal hybrid article of claim 9, wherein the one or more adhesion promoters are selected from the group consisting of 4-aminobutyltrimethoxy-silane, 4-aminobutyltriethoxysilane, 4-amino-3,3-diemethylbutyltrimethoxy-silane,N-(2-aminomethyl)-3-aminopropyltriethoxysilane, 3-aminopropyltrimeth-oxysilane, 3-aminopropyltriethoxysilane, 3-aminopropyltris(methoxyethoxy-ethoxy)silane, N-(2-aminoethyl)-3-aminopropyl-trimethoxysilane, 5,6-epoxy-hexyltriethoxysilane, (3-glycidoxypropyl)triethoxysilane, (3-glycidoxypropyl) trimethoxysilane, and 3-glycidoxylpropyltris(methoxyethoxyethoxy)silane.

11. The polymer metal hybrid article of claim 6, wherein said surface layer C and said overmolding layer D independently comprise a polyamide selected from the group consisting of PA610, PA612, PA616, PA618, PA610/6T, PA612/6T, PA1010, and blends of two or more thereof.

12. The polymer metal hybrid article of claim 6, wherein said surface layer C and said overmolded polymer D each comprise the same polyamide selected from the group consisting of PA610, PA612, PA616, PA618, PA610/6T, PA612/6T, PA1010, and blends of two or more thereof.

13. The polymer metal hybrid article of claim 6, wherein said overmolded polymer D further comprises a reinforcing agent or a functionalized thermoplastic polyolefin containing carboxyl groups.

14. The polymer metal hybrid article of claim 6, having an initial lap shear of at least 11.5 MPa when measured at 23° C.; or an initial lap shear of at least 5.5 MPa when measured at 85° C.; or a lap shear after 1000 hours humidity testing of at least 9 MPa; or a lap shear after 40 thermal cycles of at least 11.5 MPa, wherein all values are measured according to ASTM D3163.

15. A process for preparing a polymer metal laminate comprising the steps of:
a) placing a polymer metal hybrid laminate having an A/B/C structure into a heated mold on a molding machine with surface layer C facing outward;
b) closing the heated mold and further heating the polymer metal hybrid laminate to at least the T_{g} of the polyamide in surface layer C;
c) injecting into the heated mold overmolding polymer D onto surface layer C of the polymer metal hybrid laminate to provide an overmolded polymer metal hybrid article in which up to 100 percent of the exterior surface of the polymer metal hybrid article is overmolded;
d) allowing the overmolded polymer metal hybrid article to cool and solidify;
e) opening the mold and removing the overmolded polymer metal hybrid article.
